(19) United States
(12) Patent Application Publication
(10) Pub. No.: US 2003/0185956 A1
(43) Pub. Date: Oct. 2, 2003

(54) Separation method

(76) Inventor: Michelle Lorraine Gradley, Canterbury (GB)

Correspondence Address: BROMBERG & SUNSTEIN LLP, 125 SUMMER STREET, BOSTON, MA, 02110-1618, US

(21) Appl. No.: 10/312,438

(22) PCT Filed: Jul. 4, 2001
(86) PCT No.: PCT/GB01/03003

(30) Foreign Application Priority Data
Jul. 4, 2000 (GB) 0016312.1

(51) Int. Cl. A23L 1/22

(52) U.S. Cl. 426/534

(57) ABSTRACT

A method for extracting one or more desired components from an aqueous phase comprising a mixture comprising one or more further components, comprises separating the aqueous mixture (3) from a water-immiscible hydrophobic phase (2) by means of a hydrophilic membrane (1) and allowing the desired components to move out off the aqueous phase through the membrane and into the hydrophobic phase. The further components have a lower water solubility than the desired component(s), whereby the further components are substantially incapable of passing through the membrane. The method may be used for the isolation of materials from reaction mixtures for purification purposes or for the preparation of extracts of natural substances. Extracts can be produced by the method. Extracts may be produced in the form of carrier based flavours, for instance absorbed on paper or maltodextrins, or encapsulated into maltodextrins, including into glass forms; which can then be formed into powders or tablets and used as such.

This invention relates to a separation method and to extracts which may be obtained by the method. In particular, the invention relates to a method for extracting a desired component from an aqueous phase comprising one or more further components.

The ability to separate one component of a mixture from other components of the mixture relies on a difference between the properties of the components to be separated. For example, a difference in physical or chemical properties such as molecular weight, hydrophobicity, volatility, charge or binding constants (for binding to a ligand or substrate) can be exploited to allow a compound to be separated from its mixtures with other compounds.

Current separation techniques which exploit the differences in chemical or physical properties of compounds include evaporation (eg, distillation), membrane processes such as pervaporation, or processes based on size selective permeation (eg, dialysis), chemical or biological complexation, immobilisation (eg, onto ion-exchange resins), extraction into solvents of different polarity and membrane-mediated extraction.

DE 3310263 describes a process and apparatus for removing lipophilic substances from aqueous solutions. The fluid to be purified is separated from the purifying solvent by a polymer membrane. The process is said to be particularly suitable for the separation of lipophilic pollutants from blood.

WO 92/16285 describes the extraction of substances having a low molecular weight present in natural products by dialysis using a semipermeable membrane. The solvent on one of the sides of the membrane is substituted with a solvent that is immiscible with the solution from which extraction is to be effected.

U.S. Pat. No. 5,263,409 describes two types of apparatus for extracting citrus juice bittering agents. The first type of apparatus comprises a membrane that is permeable to citrus bittering agents, a means for feeding the juice across a feed side of the membrane and a means for feeding the hydrophobic extraction fluid across the membrane. The second type of apparatus comprises an immobilised liquid membrane comprising a hydrophobic extraction fluid supported within the pores of a microporous hydrophobic polymeric membrane, a means for feeding the juice and a means for feeding a basic aqueous stripping fluid.

None of the current techniques are entirely suitable for the efficient, selective separation of low molecular weight chemicals having closely similar chemical structure and physical characteristics.

There exists, for example, a need for a generally applicable technique for the selective extraction of molecules, such as oxygenated molecules (eg, terpenes), that are very often the most useful and therefore valuable components of aromas and flavours, free of corresponding molecules (which are often non-oxygenated) that contribute little, nothing or negatively to aroma and flavour.

The extraction of materials from natural products to obtain extracts having the taste and/or aroma of the natural products has previously been carried out. However, the extraction processes can be relatively complex and often fail to separate the desired components from those which are not desired.

Most flavour molecules are oxygenated and so are more hydrophilic than the bulk of the material normally extracted from plant and other sources. In order to make purified and/or concentrated preparations of the former efficient separation methods are required.

For example, following squeezing to extract the juice (which is concentrated by evaporation about 6:5 fold), orange peel is extracted by pressing or rasping to extract the so-called cold pressed oil. This oil is the source of many useful flavour and fragrance molecules. These are mainly oxygenated terpenes which constitute a minority of the oil, which is mostly composed of limonene and some other ‘hydrocarbon’ terpenes. Although when fresh, these ‘hydrocarbon’ terpenes contribute very little to the flavour of the oil, they can rapidly air oxidise to produce species with an undesirable flavour. Therefore a major objective of citrus oil processing is to reduce its hydrocarbon content.

The traditional method involves fractional distillation followed by washing. Although distillation is cheap, some volatile flavour materials are lost, some thermal degradation occurs, and the sesquiterpene hydrocarbons are not removed and so are still available for oxidation. Therefore a molecular still (thin film evaporator) has to be used to reduce residence times and to minimise thermal degradation. This approach has not been successfully taken up.

An alternative method is to wash the citrus oil with ethanolic solutions, as the valuable oxygenated terpenes are soluble in ethanol, whereas the hydrocarbon terpenes are insoluble. The hydrocarbon extract is called ‘washed citrus oil’, and the alcohol solution containing concentrated oxygenated terpenes is called ‘washed extracts’. Although effective, this counter-current process is difficult to operate because of the difficulty in efficiently contacting the two phases without emulsifying them so finely that their subsequent separation is difficult. Counter-current extraction with liquid carbon dioxide, which has a polarity as an extracting solvent close to that of hexane, has been used. However this method suffers from high costs, particularly due to high capital costs.

The present invention seeks to provide an improved process for separating one or more components from a mixture in the aqueous phase which, for certain separations, can be carried out relatively simply, in a good yield with a high degree of selectivity.

The present invention also aims to provide an improved process for the production of natural extracts. It is a further aim of the present invention to provide extracts having improved flavour and/or aroma properties compared to extracts produced by other extraction methods.

According to the present invention, there is provided a method for extracting one or more desired components from an aqueous phase comprising a mixture comprising one or more further components, the method comprising separating the aqueous mixture from a water-immiscible hydrophobic phase by means of a hydrophilic membrane and allowing said one or more desired components to move out of the aqueous phase into and through the membrane and then into the hydrophobic phase, characterised in that said further components have a lower water solubility than the desired component, whereby the further components are substantially incapable of passing through the membrane.

The method of the invention relies on the selective movement from the aqueous phase across the hydrophilic membrane into a second hydrophobic phase of one or more compounds having (i) a water solubility which is greater than that of the other components of the mixture, (ii) ability to dissolve and pass through a hydrophilic membrane, and (iii) solubility in a water-immiscible hydrophobic phase. Surprisingly, it has been found that compounds having a higher water solubility generally move across the membrane into the hydrophobic phase in preference to compounds having a lower water solubility. It was unexpected that the more water soluble the compound is, the greater its tendency to pass out of the aqueous phase and into the hydrophobic phase.

The ability of the method of the invention to provide a selective separation and isolation of one or more components from a mixture requires a difference between the water solubility of the one or more desired components and the water solubility of the one or more further components of the mixture.

In the invention the one or more desired component(s) are typically more soluble in water than in the hydrophobic phase (for example, water-immiscible organic solvent) so as to be able to pass across the hydrophilic membrane but also have some solubility in the water-immiscible hydrophobic phase, so that they can accumulate in the water-immiscible hydrophobic phase. Also, preferably the hydrophobic phase does not pass across the hydrophilic membrane, so those molecules with a more hydrophobic character than the one or more desired components present in the aqueous phase cannot be extracted across the membrane and into the water-immiscible hydrophobic phase.

Hence, without wishing to be bound by theory it is believed that according to the method of the present invention, separation and/or purification of the one or more desired component(s) will be achieved because any molecules that are more hydrophobic than the one or more desired components will not pass through the hydrophilic membrane, and any molecules that are more hydrophilic than the one or more desired component(s) will not dissolve into the hydrophobic phase even though they can readily pass through the hydrophilic membrane.

By using the system of the invention with a hydrophilic membrane and a water-immiscible hydrophobic phase, further component(s) which are more hydrophilic than the desired component(s), so that they can pass through the hydrophilic membrane, cannot dissolve into the hydrophobic phase.

In some embodiments of the invention, the method allows compounds having a water solubility of greater than about 0.010 gl⁻¹ to pass through the membrane into the hydrophobic phase with components of the mixture which have a water solubility of less than about 0.010 gl⁻¹ remaining in the aqueous phase. However, it will be appreciated that the actual solubility threshold at which a compound can pass through the membrane may depend upon the nature of the membrane used and of the aqueous and hydrophobic phases which are employed in any given case. Therefore, the solubility threshold may, in practice, be greater than or less than 0.010 gl⁻¹, although this limit has been found to be particularly suitable for certain separations. Solubilities are based on deionised water at 25° C.

The aqueous phase containing the one or more components which are desired to be extracted comprises water, the one or more components, and one or more further components of the mixture. The aqueous phase may contain other solutes or water miscible solvents which may assist the separation process. Each of the components of the mixture may be present in the aqueous phase in solution, in the solid phase or in a separate liquid phase, such as in the form of particles or droplets suspended or dispersed in the aqueous phase.

The mixture from which the one or more desired components are extracted in the method of the invention may contain the one or more desired components in relatively small amounts up to relatively large amounts (eg, 1% to 99% by weight). When the mixture contains the one or more desired components in relatively small amounts, the method can be viewed as being a selective extraction process. When the mixture contains the one or more desired components in relatively large amounts, on the other hand, the method can be considered as a purification technique.

The method of the invention can be used to extract either a single desired component from a mixture, or two or more desired components from a mixture. Where two or more desired components are extracted from the mixture, they may be separated from each other by repeating the method of the invention using a different membrane and/or different aqueous and/or hydrophobic phases or by employing conventional separation techniques. It will be appreciated that the separation of a single desired component will be preferred for some applications (such as, for example, the preparation or purification of a single compound) but that, for other applications, the separation of two or more components from a mixture can be desirable (such as, for example, the production of an extract of a natural product).

Generally, it is the desired product which is the useful material obtained from the method of the invention. However, the components which do not pass through the membrane in the method of the invention (ie, the retained components) may be useful in their own right. The retained components may be termed the “retentate”.

The method of the invention can be used, for example, for the isolation of desirable compounds from natural products such as juices or essential oils or for the removal of undesirable compounds from these natural products. The method may also be used, for example, in the isolation of products from enzymatic conversions, including fermentation broths or bioconversion reactions. When the method is used for the isolation of the products of enzymatic conversions, the product or products may be extracted from the reaction mixture in situ as the reaction proceeds by carrying out the enzymatic conversion, preferably using microorganisms, in the aqueous phase in the presence of the membrane with the hydrophobic phase on the other side of the membrane. This latter method, involving extraction in situ, can be particularly advantageous where the product is inhibitory to the reaction or toxic to the micro-organism used in the process or where the product is unstable in the environment in which it is produced, due to chemical instability or metabolism by a micro-organism, for example.

Thus, the aqueous phase may comprise enzymes and/or a microbial culture medium, preferably for culturing bacterial or fungal cells. The cells may be absent from the aqueous phase or they may be present in whole (live or dead) or lysed form.

Examples of extractions which can be carried out with high yield and selectivity using the method of the invention include: the separation of sesquiterpenes, such as the extraction of nootkatone from mixtures with valencene; and the separation of epoxides from alkenes, such as the extraction of 1,2-epoxyoctane from mixtures with 1,2-octene.

From the foregoing description, it will be understood that the method of the invention can be particularly useful in separating one desired compound from its mixture with other compounds, where the mixture contains a compound which differs from the desired compound only in that it contains a further single functional group, especially a polar group containing a sulphur atom or, preferably, an oxygen atom (eg, a hydroxyl or epoxide group). Hence, the method of the invention can be particularly effective for the selective extraction of the reaction products of reactions of relatively non-polar molecules by the introduction of polar functional groups.

The method of the invention can be applied to the production of flavours and/or aromas for use in the food industry. The one or more desired components may be partly or wholly responsible for the flavour and/or aroma of a natural product. The aqueous phase may, therefore, comprise a suspension, dispersion or solution of a natural product or an extract thereof, including an infusion obtained by treatment of the natural product with hot water. The natural product or extract may be obtained directly from the naturally occurring source of the natural product, for example by treatment with hot water, or may be obtained following a pretreatment of the naturally occurring source of the natural product to assist in the release of the natural product eg, by treatment of the naturally occurring source with an enzyme, such as a glycosidase.

The method of the invention can also be applied to the production of aromas for use in cosmetic or personal care products.

In particular, the method of the present invention can be used to produce desirable fragrances and/or flavours for use in the food and/or beverage industry or desirable fragrances for use in cosmetic or personal care products. The term “desirable” is intended to mean that the one or more desired components, which may be responsible for flavours or fragrances, do not have an unacceptable level of bitterness, for example, or have an objectionable odour or any other quality that may render the flavours or fragrances unacceptable or undesirable to consumers. Thus it is preferred that bittering agents, such as limonoids and flavonoids, for example limonin and nomilin, do not constitute the desirable fragrances and/or flavours for use in the food and/or beverage industry to the detriment of their commercial value.

The membrane which is used in the method of the invention is hydrophilic. The selection of a suitable membrane for any particular extraction can be readily made by the skilled person. Suitable membranes include, for example, hydrophilic polymers such as acrylic co-polymers, modified polyether sulphones, polysulphones and cellulose or other modified or unmodified cellulosic polymers, eg, cellulose acetate membranes.

Other suitable membranes may be in the form of hollow fibres. Hollow fibre membranes are particularly useful when the method of the invention is performed on a larger scale. They have the advantage of providing a large area (m²) of membrane surface per area (m²) of floor space occupied. Suitable hollow fibre membranes include polysulphone membrane and polyacrylonitrile membrane. The properties of preferred hollow fibre membranes are shown in the table below.

| | | | | | | | | |
|---|---|---|---|---|---|---|---|---|
| | | Water | | Fibre | Module | Module | Max² Inlet | Max² |
| Module | MWCO | Flux | Area | Bore | Length | outside diameter | Pressure | ΔP |
| Type | dalton | (1/hr) | (m²/ft²) | (mm) | (mm/in) | (mm/in) | (bar/psi) | (bar/psi) |

Polyacrylonitrile

| | | | | | | | | |
|---|---|---|---|---|---|---|---|---|
| ACP-0053 | 13,000 | 2.2 | 0.012/0.13 | 1.4 | 130/5.1 | 20/0.8 | 1/15 | 1/15 |

Polysulphones

| | | | | | | | | |
|---|---|---|---|---|---|---|---|---|
| SLP-0053 | 10,000 | 5.7 | 0.015/0.16 | 1.4 | 130/5.1 | 20/0.8 | 1/15 | 1/15 |
| SEP-0013 | 3,000 | 2.5 | 0.017/0.18 | 0.8 | 130/5.1 | 20/0.8 | 1/15 | 1/15 |

MWCO = molecular weight cut off

These hollow fibre membranes are supplied by Pall Ultrafine Filtration Co. (Pall Corp) of New York. All of the module components meet the requirements for biological tests listed in the United States Pharmacopoeia for Class VI Plastics at 121° C. and are also constructed from materials listed in Title 21 of the US Code of Federal Regulations. The materials are resistant to a wide range of chemical agents and tolerate the pH range 1-14.

The hydrophobic phase can take a number of different forms.

In one embodiment of the invention, the hydrophobic phase is a solvent which is immiscible with water. Solvents which may be used as a hydrophobic phase include, for example, branched and unbranched alkanes. Preferably, the alkanes are liquid at room temperature. Suitable alkanes include C₆-C₁₀ straight chain alkanes eg, n-hexane and n-decane. Preferably the hydrophobic phase is hexane or comprises hexane. The hydrophobic phase may comprise a single solvent or a mixture of different solvents. Where the solvent comprises a mixture of different solvents, these are preferably miscible. During the method of the invention, the more water soluble one or more desired compounds pass into the hydrophobic phase and will typically form a solution with the solvent. The one or more desired components can be isolated from the hydrophobic solvent by conventional techniques, including, for example, removal of the solvent by evaporation at elevated temperature and/or reduced pressure to leave behind the one or more desired components.

It is typically preferred not to use a solvent such as chloroform in which water is soluble, or which dissolves to some extent in water, in the method of the invention. Without wishing to be bound by theory, it is believed that the preferred solvents, such as the alkanes mentioned above, can not pass through the hydrophilic membrane and dissolve the relatively hydrophobic molecules of the further components present in the aqueous phase. This inhibits the relatively hydrophobic molecules of the further components in the aqueous phase from being transported across the hydrophilic membrane into the hydrophobic phase.

The method of the invention may be carried out in any suitable apparatus in which the aqueous phase can be separated from the hydrophobic phase by a membrane. Preferably, the aqueous phase and/or the hydrophobic phase are moved relative to the membrane (eg, by stirring or other methods of causing circulation in liquids). Apparatus suitable for use in the method will be well-known to those skilled in the art. One illustrative form of apparatus in which the method of the invention may be carried out comprises the membrane in the form of a tube which contains the hydrophobic phase. The tube is at least partly immersed in the aqueous phase. The hydrophobic solvent may be substantially static in the tube, in which case the tube may be open at one or both ends or sealed at both ends. Alternatively, the hydrophobic liquid may flow along the tube, and the tube may pass into and out of the aqueous phase, to effect continuous extraction of the one or more components from the aqueous phase or the separation may employ a flat membrane with either cross-flow or tangential separator configurations.

In another aspect, the invention provides extracts obtainable by the method of the invention. The extracts comprise compounds responsible for the flavour and/or aroma of a food or beverage. The extracts include extracts of the food or beverage itself and components of the food or beverage (such as natural food ingredients eg, herbs). Extracts of the invention include extracts of plant origin- such as fruit (eg, grapefruit, blackcurrant, lemon, orange, mandarin, bergamot and lime), leaf (eg, herbs, such as rosemary) and other plant material (eg, cocoa and malt). Other extracts include extracts from edible fungi (eg, from mushrooms), from dairy products (eg, milk, cheese and yoghurt), from fermentation products (eg, beer, wine, soy sauce) and from savoury products (eg, meat-based products and protein hydrolysates). Those skilled in the art will be aware of the compound or compounds which are chiefly responsible for the flavour and/or aroma of the particular substance to be extracted. By using different solvents in the method of the invention, extracts having different flavour profiles may be obtained.

The method of the invention may also be used to extract desirable flavours from waste products. For example cocoa, beer and coffee flavours can be extracted from waste materials such as cocoa shells, spent yeast and coffee grounds respectively.

The extracts may be formulated together, typically in a “ready to use” form, with a carrier material, as described hereinafter. This formulation of the extracts with a carrier material may form part of the method of the invention rather than being a separate step after the extracts have been produced according to the method of the invention. For example, if the carrier material is an absorbent substrate such as paper, it may be added to the solution of the extract which has passed through the membrane, before the solvent is evaporated. Alternatively, if the absorbant is, for example a maltodextrin it may be added in the same way. The absorbed flavour can then be obtained in an easy to use form, for example by addition to a blend or by tableting.

In another aspect, the invention comprises an extract of the invention together with a carrier.

The carrier may comprise a food or beverage product eg, grapefruit, blackcurrant, lemon, orange, mandarin, bergamot and lime, tea leaf material or herbs, such as rosemary, and other plant material eg, cocoa and malt, edible fungi eg, mushrooms, dairy products eg, milk, cheese and yoghurt or fermentation products eg, beer, wine and soy sauce and savoury products eg, meat-based products and protein hydrolysates. Thus, the extract of the invention may be used to modify or to increase the flavour and/or aroma provided by a food or beverage product.

Alternatively, the carrier may be a conventional food or beverage flavour or aroma, such as conventional tea extract. By the term “conventional” we mean any food or beverage flavour and/or aroma or extract obtained by conventional methods known in the art.

The carrier may comprise paper, in which case the extract may be absorbed into and/or onto the paper. The paper may be paper that is suitable for use in making tea bags and bags that may be used to contain other substances that may be subject to infusion. Alternatively, the paper may be suitable for use as packaging (eg, cardboard or paperboard).

Impregnating the inside of a package for a conventional food or beverage product with an extract having the aroma of that product allows the consumer to experience a greater aroma of the product when opening the packaging.

The carrier for the extract may be a liquid, such as glycerol. Liquid carriers allow the product to be used in a variety of food and/or beverage applications. Furthermore, formulating a product in liquid form allows it to be dispensed by a variety of different routes, such as, for example, from a spray dispenser.

Carriers include carbohydrates, preferably mono-, di- or poly-saccharides, which are preferably water soluble. Suitable carriers of this type include maltodextrin, sorbitol, glucose, sucrose and mixtures thereof. The extract may be encapsulated in a matrix of these carriers, thus preventing the compounds responsible for the taste and/or aroma of the extract from being lost by evaporation before it is used. The product may therefore be in the form of a glass comprising a matrix of the carrier with the extract encapsulated in the matrix. This form of the product is preferably in the form of a powder or another solid body such as a tablet.

Tablets of the invention may be in a form suitable for easy use and dispensation (eg, by having a size of less than 1 cm, such as from 2 mm to 8 mm). The tablets may comprise two or more extracts, in which case one or more of the extracts may be produced by the method of the invention with, optionally, any remaining extracts produced in other ways. The tablets may comprise other materials such as, for example, acidulants (eg, lemon juice), colours, caffeine, flavours (eg, vanillin, citrus or mint flavours), whitener, sweeteners, thickeners, emulsifiers, “fizzing” agents such as sodium bicarbonate, vitamins, antioxidants (eg, ascorbic acid), preservatives and mixtures thereof. The tablets may be wrapped or coated, preferably with edible materials (eg, rice paper, edible foil or gelatin).

Preferably, the tablets are in unit dosage form. For example, in the case of a tablet for addition to hot or cold water to form a beverage, one tablet preferably provides a drink of standard size (eg, one cup or glass).

The tablets of the invention may contain some of the retentate from the method of the invention (ie, the material which does not pass through the hydrophilic membrane). Preferably, the amount of the retentate by weight does not exceed the amount of extract by weight by a factor of more than 10.

The invention is illustrated, by way of example only, by reference to the accompanying drawing wherein:

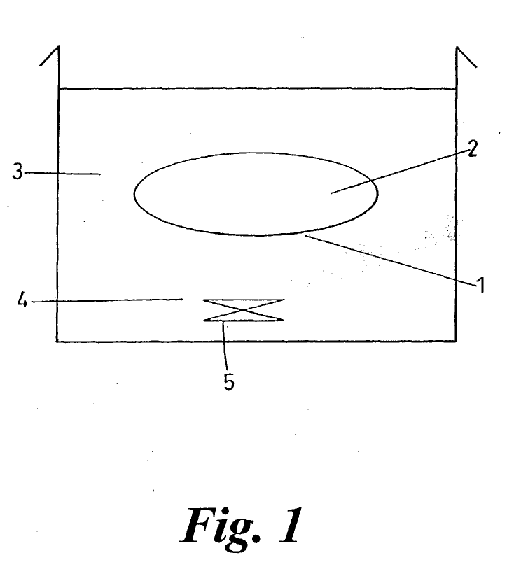

FIG. 1 is a schematic diagram of an apparatus according to the invention.

In FIG. 1, membrane 1 is in the form of a sealed tube and contains a hydrophobic solvent 2. Membrane 1 is of a hydrophilic membrane (such as of cellulose) and is disposed within aqueous phase 3 in container 4 containing the one or more desired components. The one or more desired components are typically present in aqueous phase 3 together with other components. Membrane 1 remains sealed as aqueous phase 3 is stirred by stirrer 5. The one or more desired components which it is desired to extract from the aqueous phase 3 pass though membrane 1 and into solvent 2.

After the required degree of extraction has taken place, the solvent 2 can be recovered from membrane 1, for example by unsealing membrane 1 or cutting it open. The solvent 2 may then be removed, for example by evaporation under reduced pressure, to give the one or more desired components, as concentrated or solid products.

The following non-limiting examples illustrate the present invention. Throughout the following examples, unless otherwise stated, the term “membrane” refers to a cellulose acetate membrane. The cellulose acetate membranes used typically had a molecular weight cut off of about 12,000 daltons. In the examples and throughout the specification, all percentages are percentages by weight unless indicated otherwise.

### EXAMPLES

SECTION ONE (Examples 1 to 6)—Product Isolation in a Model Membrane Bioreactor

Separation experiments were carried out in a small model membrane reactor which consisted of an upper and lower chamber separated by 0.002 m² of membrane. Thorough mixing was ensured by use of a magnetic stirrer with a separate stirring bar contained within each chamber. Membrane separations were carried out at room temperature (22° C.).

### Example 1

Separation of nootkatone from valencene

| | |
|---|---|
| Membrane | Dialysis membrane (obtained from Medical |
| | International Ltd. 239 Liverpool Road, London N1 |
| | lLX). |
| Membrane structure | Cellulose acetate; thickness 0.05 mm (M.W. cut-off |
| | 12-14,000 Da) |
| Method | The lower chamber contained: deionised water, |
| | 39 ml; valencene, 75 mg; and nootkatone, 10 mg. |
| | The upper chamber contained n-decane, 50 ml. |
| | The presence of nootkatone and valencene in the |
| | decane was assayed by gas chromatography |
| | (method described in the Analytical Section). |
| Separation | After 24 h, 40% of added nootkatone had been |
| | recovered into the decane. Valencene was not |
| | detected in the decane at any time during the |
| | experiment. |
| Rate of flux | 0.08 g nootkatone h⁻¹m⁻². |

### Example 2

Example 1 was repeated using the following conditions:

| | |
|---|---|
| Membrane | ‘Versapor’ (trade mark) (Pall Gelman Laboratory, |
| | Portsmouth, UK) |
| Membrane Structure | Acrylic co-polymer on non-woven support; |
| | thickness 0.16 mm; porosity 0.2 μm |
| Method | As above (the membrane can be used either way |
| | round) with hexane maintained at 0.3-0.5 bar |
| | irrespective of the flow-rate used |
| Separation | Complete selectivity for nootkatone |
| Rate of flux | 0.082 g m⁻¹m⁻² for nootkatone |

### Example 3

Example 1 was repeated using the following conditions:

| | |
|---|---|
| Membrane | Supor (trade mark) (Gelman Sciences, |
| | Northampton, UK) |
| Membrane structure | Modified polyether sulphone |
| Method | As above |
| Separation | Complete selectivity for nootkatone |
| Rate of flux | 0.130 g h⁻¹m⁻² for nootkatone |

### Example 4

Separation of 1,2-epoxyoctane from 1-octene

| | |
|---|---|
| Membrane | Dialysis membrane as described in Example 1 |
| Method | The lower chamber contained: deionised water, |
| | 36 ml; 1,2-epoxyoctane, 80 mg; and 1-octene 70 mg. |
| | The upper chamber contained n-decane, 50 ml. |
| | The presence of 1,2-epoxyoctane or 1-octene in |
| | the decane solvent was determined as described in |
| | the Analytical Section. |
| Separation | After 7 h, 22% of 1,2-epoxyoctane which had been |
| | added to the lower chamber, had been recovered |
| | into the decane. Only a trace amount of 1-octene |
| | was detected in the decane. |
| Rate of flux | 1.45 g h⁻¹m⁻² for 1,2-epoxyoctane |

### Example 5

Selective extraction of nootkatone from grapefruit peel

| | |
|---|---|
| Membrane | Dialysis membrane as described in Example 1 |
| Method | The lower chamber contained: deionised water, |
| | 35 ml; and 20 g macerated, depithed grapefruit peel |
| | containing the essential oil components |
| | nootkatone, 4.3 mg and limonene, 135 mg. The |
| | upper chamber contained n-decane, 50 ml. The |
| | presence of nootkatone and valencene in the |
| | decane was determined as described in the |
| | Analytical Section. |
| Separation | Selective extraction of nootkatone out of grapefruit |
| | peel from the major grapefruit essential oil |
| | component limonene. After 2.5 days, 28% |
| | (1.2 mg) of nootkatone and 5% (4.6 mg) of |
| | limonene had been recovered into the decane. |

### Example 6

Selective Extraction of Carvone From Water in the Presence of Limonene

The approximate solubility of limonene in water is 13 mg/l and the solubility of carvone in water is approximately 600 mg/l.

A volume of deionised water (100 ml) containing 100 mg limonene and 20 mg carvone was placed in a 250 ml conical flask. Dialysis tubing (cellulose acetate visking tubing MW cut off 12-14,000 Da) containing 50 ml n-decane was added to the flask and the whole incubated at 30° C. with shaking at 150 rpm for 45 hours. After this time, the n-decane phase was assayed by gas chromatography (method given below) and revealed the presence of 2.0 mg limonene and 8 mg of carvone representing 2% and 40% of the limonene and carvone originally added to the water phase, respectively.

Section Two (Examples 7 and 8)—Isolation of Products From Fermentation Broths or Bioconversion Reactions. Separation of Nootkatone From Valencene.

Product recovery experiments were carried out in fungal or bacterial cultures or in suspensions of fungal or bacterial cells. Reaction media contained: unreacted substrate valencene at 0.3-1.4 mg ml⁻¹ and the reaction products nootkatol and nootkatone in concentrations ranging from 0.02-0.2 mg ml⁻¹. Nootkatol and nootkatone differ from the substrate valencene by the presence of only a single hydroxyl or a single keto group respectively.

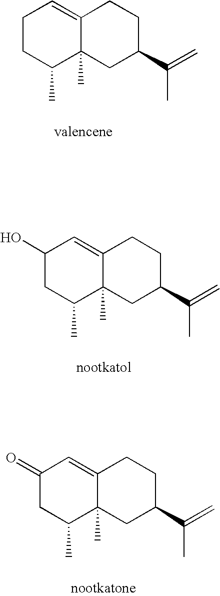

### Example 7

Dialysis tubing (as described in Example 1) pre-soaked in deionised water, containing n-hexane (50 ml) was added to each of two separate fungal cultures. On addition of hexane filled tubing, reaction mixtures contained the following:

Culture one contained culture broth and biomass (100 ml), residual valencene (approximately 35 mg) and product nootkatone (2.3 mg). Culture two contained culture broth and biomass (100 ml), residual valencene (approximately 33 mg), product nootkatone (3.8 mg), and Tween 80 (trade mark) (1.3 g).

After 48 h extraction time (30° C., shaking at 160 rpm), 96% of nootkatone had been recovered from culture broth one into n-hexane in the dialysis tubing. The remaining nootkatone was detected in the culture broth. Valencene was not detected in the n-hexane extraction solvent. The efficiency of extraction from culture broth two was 68%. The remaining nootkatone was detected in the culture broth. A trace amount of valencene was detected in the extraction solvent.

### Example 8

Dialysis tubing (details described in Example 7) pre-soaked in deionised water, containing n-decane (50 ml) was added to a fungal culture medium containing: culture broth and biomass (100 ml); residual valencene (approximately 150 mg) and the products nootkatol and nootkatone (approx. 3.3 mg combined weight). After 72 h incubation (conditions described in Example 7) 100% of the nootkatol and nootkatone products had been recovered into the n-decane in the dialysis tubing. Valencene was not detected in the n-decane.

Analytical Methods

Gas Chromatography (g.c.)

Analysis of valencene, nootkatone, 1,2-epoxyoctane and 1-octene.

Column—SE-30 capillary (Alltech, Carnforth, Lancs, UK), ID 0.32 mm, film thickness 0.25 μm.

Temperature program 200° C. for 5 min. 10° C. min⁻¹

Injector/detector temperature—300° C.

Carrier gas-helium, head pressure 0.35 bar

Section Three (Examples 9 to 14)—Separation of Extracts From Natural Products

### Example 9

Beer Extract

1 litre (2×500 ml cans) of Fosters (trade mark) lager beer containing 4.0% alcohol was transferred to a 2 litre conical flask, poured with care to minimise the head of froth. 200 ml hexane were transferred into a length of moistened dialysis tubing tied at one end. Twice the length occupied by the beer was allowed to allow for expansion of hexane. Air was expelled and the tube was knotted at the end. The dialysis tube and hexane were transferred into the beer. This was extended to 6 hours, shaken at 150 rpm at 280° C.

After 6 hours the dialysis tubing was removed from the beer and dried to remove any traces of water. The hexane was removed and evaporated at 40° C., down to a few mls, then taken to dryness under a stream of helium.

The process yielded 10.1 mg of product having a strong beer aroma. Compared to a beer extract made by a direct extraction with hexane in a separating funnel, the beer extract has a cleaner aroma and is less vinegary.

### Example 10

Cocoa Extract

Natural cocoa nibs were coarsely ground with a pestle and mortar. 100 g ground nibs were ground to a paste with hot (60° C.) water. The resulting cocoa sludge was made up to 1 litre with distilled water at 60° C. and stirred for 15 minutes. This cocoa liquor was filtered through a mesh bag. The solids were pressed to remove liquor and the liquor was made to a total volume of 1 litre. 500 ml of this cocoa liquor was extracted in a separating funnel with 200 ml hexane and 500 ml cocoa liquor was extracted according to the method of the invention. That is, 200 ml hexane was transferred to a cellulose acetate dialysis tubing (as used in Example 1) of capacity 400 ml, wetted with distilled water and knotted. The hexane filled dialysis tube was transferred to a 2 litre conical flask containing 500 ml of cocoa liquor. The flask was shaken at 200 rpm at 30° C. for 5 hours. The method of the invention produced an extract with an intense chocolatey aroma, as a pale yellow solid of a few milligrams yield.

By comparison, extraction of the second 500 ml aliquot of cocoa liquor with hexane in an extracting funnel produced a fatty solid in yellow oil with a less intense aroma of chocolate.

### Example 11

Cocoa Extract

28 g of cocoa shells in 250 ml of hot water were heated and stirred for 15 minutes. The mixture was then filtered and the mulch pressed to produce about 150 ml of liquor. The liquor was then extracted using 75 ml of hexane contained in dialysis tubing for 4 hrs at 30° C. and shaking at 700 rpm, after which the hexane was evaporated to dryness to produce (about 5 mgs) of a beige-yellow solid with a woody-nutty chocolate-like aroma.

### Example 12

Blackcurrant Extract

Two batches of 500 ml blackcurrant were made up each from 250 ml Ribena™ blackcurrant drink and 250 ml hot distilled water, mixed thoroughly by inversion. One batch was extracted in a separating funnel by shaking with 200 ml hexane. The hexane and aqueous layers were allowed to separate overnight. The emulsion of hexane and blackcurrant formed was separated by centrifugation at 4000 rpm for 20 minutes. The hexane was removed, evaporated down and taken to dryness under helium. The second 500 ml batch of blackcurrant was transferred to a 21 conical flask. A length of dialysis tubing knotted at both ends and containing 200 ml hexane was put into the flask. The flask was shaken at 200 rpm at 30° C. for 20 hours. The hexane was recovered, evaporated off and taken to dryness under helium. Extraction of blackcurrant by conventional hexane extraction produced 31.1 mg of a white solid with a sweet, intense blackcurrant aroma.

The method of the invention produced 13.6 mg of a white crystalline solid with a more acidic blackcurrant aroma. This example shows that sulphurous aroma compounds can be extracted by the method of the invention, as well as the oxygenated flavour materials also described herein. These include 1-p-menth-8-thiol-3-one.

### Example 13

Rosemary Extract

24 g dried rosemary was steeped in 400 ml hot distilled water. This was simmered for 20 minutes, the rosemary was removed and pummelled with a pestle and mortar and transferred back to the liquor for a further 5 minutes. Rosemary leaves were filtered off and pressed and the liquor made back up to 400 ml. The liquor was transferred to a 21 conical flask. A length of dialysis tubing, knotted at both ends, containing 200 ml hexane was put into the flask. The flask was shaken at 200 rpm at 30° C. for 20 hours. The hexane was recovered, evaporated off and taken to dryness under helium. 26.3 mg of a yellow oily solid was produced with a powerful rosemary aroma.

### Example 14

Malt Extract

300 g malt extract was mixed with 1 litre boiling distilled water. 500 ml malt liquor was extracted with 200 ml hexane in a separating funnel. The emulsion of hexane and malt was separated by centrifugation at 4000 rpm for 20 minutes. The hexane layer was recovered, evaporated off and taken to dryness under helium. 500 ml malt liquor was transferred to a 2 litre conical flask. A length of dialysis tubing, knotted at both ends, containing 200 ml hexane was put into the flask. The flask was shaken at 200 rpm at 30° C. for 20 hours. The hexane was recovered, evaporated off and taken to dryness under helium. The method of the invention produced 3.2 mg of a yellow oil with an intense malt aroma. Direct hexane extraction produced 45.9 mg of a yellow fatty solid and oil with an intense but less “clean” malt aroma.

### Example 15

Product in Tablet Form

General Method

The ingredients were weighed out and then well mixed to ensure even distribution between tablets. The required amount for the tablet was then measured out into the mould, then subjected to high pressure by means of a tableting device.

The resulting tablets dissolved rapidly in cold water upon moderate agitation.

Malt Tablet

| Ingredient | % by weight | Weight to give 100 ml drink (g) |
|---|---|---|
| Icing Sugar | 90.02 | 6.5 |
| Sodium Bicarbonate | 3.5 | 0.25 |
| Malt Extract* | 1.4 | 0.1 |
| Citric Acid | 4.8 | 0.35 |
| Vanillin | 0.14 | 0.01 |
| Ascorbic Acid | 0.14 | 0.01 |
| Total | | 7.22 |

*Produced according to Example 14

1. A method of extracting one or more desired components from an aqueous phase comprising a mixture comprising one or more further components, the method comprising separating the aqueous mixture from a water immiscible hydrophobic phase by means of a hydrophilic membrane and allowing said one or more desired components to move out of the aqueous phase through the membrane and into the water immiscible hydrophobic phase, characterised in that said further components have a lower water solubility than the desired component, whereby the further components are substantially incapable of passing through the membrane.

2. A method as claimed in claim 1, wherein the one or more desired components are more soluble in water than in the hydrophobic phase.

3. A method as claimed in claim 1, wherein the one or more desired components have a water solubility of greater than 0.010 gl⁻¹.

4. A method as claimed in claim 1, wherein the further components have a water solubility of not more than approximately 0.010 gl⁻¹.

5. A method as claimed in any one of claims 1 to 3, wherein the one or more desired components and the further components are sesquiterpenes.

6. A method as claimed in any one of claims 1 to 4, wherein the one or more desired components comprise compounds responsible for the aroma and/or taste of a food or beverage or the aroma of a cosmetic or personal care product.

7. A method as claimed in claim 5 or 6, wherein the desired component is nootkatone and the further component is valencene or valencene and other chemicals present in citrus fruit extracts.

8. A method as claimed in any one of claims 1 to 3, wherein the desired component is an epoxide and the further component is an alkene.

9. A method as claimed in claim 8, wherein the desired component is 1,2-epoxyoctane and the further component is 1-octene.

10. A method as claimed in claim 6, wherein the one or more desired components comprise compounds responsible for the aroma and/or taste of beer and the aqueous phase comprises beer.

11. A method as claimed in claim 6, wherein the one or more desired components comprises compounds responsible for the aroma and/or taste of chocolate and/or cocoa.

12. A method as claimed in claim 6, wherein the one or more desired components comprises compounds responsible for the aroma and/or taste of malt.

13. A method as claimed in any one of claims 1 to 12 wherein the hydrophilic membrane comprises one or more materials selected from an acrylic co-polymer, modified poly(ether)sulphone, polysulphone, cellulose acetate, cellulose, and polyacrylonitrile.

14. A method as claimed in any one of claims 1 to 13, wherein the aqueous phase comprises a microbial culture media bioreactor involving enzyme conversions of defined or undefined chemicals or biological materials.

15. A method as claimed in claim 14, wherein the media is for the culturing of bacterial or fungal cells.

16. A method as claimed in any one of claims 1 to 15, wherein the membrane is provided in the form of hollow fibres, a tube or sheet which contains or separates the hydrophobic phase, with the aqueous phase on one side of the membrane and the hydrophobic phase on the other.

17. A method as claimed in any one of claims 1 to 16, wherein the hydrophobic phase comprises a water immiscible solvent.

18. A method as claimed in claim 17, wherein the water immiscible solvent is selected from decane and hexane.

19. Extract obtainable by the method of any one of claims 6 to 18.

20. Product comprising an extract of claim 19 together with a carrier.

21. Product as claimed in claim 20, wherein the carrier comprises a food or beverage product.

22. Product as claimed in claim 20, wherein the carrier comprises a conventional food or beverage flavour and/or aroma.

23. Product as claimed in claim 20, wherein the carrier comprises paper.

24. Product as claimed in claim 23, wherein the paper is suitable for forming tea bags or is suitable for use as packaging.

25. Product as claimed in claim 20, wherein the carrier is glycerol.

26. Product as claimed in claim 20, wherein the carrier is a carbohydrate.

27. Product as claimed in claim 26, wherein the carrier is a mono-, di- or poly-saccharide.

28. Product as claimed in claim 27, wherein the carrier is maltodextrin.

29. Product as claimed in any one of claims 26 to 28 which is in the form of a powder or a tablet.

30. Product as claimed in any one of claims 26 to 29 wherein the carrier is in the form of a glass in which the extract is encapsulated.

31. A retentate obtainable by the method of any one of claims 1 to 18.
